(19) United States
(12) Patent Application Publication
(10) Pub. No.: US 2016/0372861 A1
(43) Pub. Date: Dec. 22, 2016

(54) ELECTRICAL CONNECTION ASSEMBLY

(71) Applicant: LOTES CO., LTD., Keelung (TW)

(72) Inventor: Ted Ju, Keelung (TW)

(21) Appl. No.: 14/841,103

(22) Filed: Aug. 31, 2015

(30) Foreign Application Priority Data
Jun. 17, 2015 (CN) 201520418129.4

(51) Int. Cl. H01R 13/629; H01R 13/62; H01R 12/70

(52) U.S. Cl. CPC H01R 13/629; H01R 12/7076; H01R 13/62

(57) ABSTRACT

An electrical connection assembly for electrically connecting a chip module having a mask and a circuit board, includes a socket, a load plate, and a clamping apparatus. The socket is located between and electrically conducting the chip module and the circuit board. The load plate is located at an outer side of the socket, and having a pressing member and an installing member fixed to the circuit board. The pressing member has an open and a close position relative to the installing member. The installing member has a first identifier. The clamping apparatus has a second identifier corresponding to the mark. At the open position, the clamping apparatus clamps the chip module, and aligns with the first identifier by the second identifier, thereby placing the chip module on the socket. At the close position, the pressing member fixes the clamping apparatus with the chip module to the circuit board.

### CROSS-REFERENCE TO RELATED APPLICATION

This non-provisional application claims priority under 35 U.S.C. §119(a) on Patent Application No. 201520418129.4 filed in P.R. China on Jun. 17, 2015, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates to an electrical connection assembly, and more particularly to an electrical connection assembly for electrically connecting a chip module and a circuit board.

### BACKGROUND OF THE INVENTION

A mainboard of each computer is configured with a chip module. The chip module is electrically conducted to the mainboard by an electrical connector. The bottom of the chip module is densely provided with multiple contact points. Correspondingly, the electrical connector is internally provided with multiple terminals, used for contacting the multiple contact points. Certainly, to ensure correct electrical cooperation between the chip module and the mainboard, the mainboard is respectively provided with multiple conduction points corresponding to the multiple contact points. In a specific implementation, the electrical connector is first soldered to the mainboard, the multiple terminals are correspondingly soldered to the multiple conduction points, and then the chip module is placed at the electrical connector. When the chip module is placed at the electrical connector, an operator easily mounts the chip module reversely, resulting in that the chip module and the mainboard have an abnormal electrical conduction, and cannot be matched, or slip off, causing damage to the terminals and contact points, or even the chip module being short-circuited and burned down. Because the chip module has the highest price in the entire computer, replacement of the chip module causes a high production cost of the entire computer, which is unfavorable to competitiveness.

Therefore, a heretofore unaddressed need exists in the art to address the aforementioned deficiencies and inadequacies.

### SUMMARY OF THE INVENTION

In one aspect, the present invention relates to an electrical connection assembly for correctly mounting a chip module by identifying a load plate and a clamping apparatus.

In one embodiment, an electrical connection assembly is used for electrically connecting a chip module and a circuit board. The chip module has a mark. The electrical connection assembly includes a socket, a load plate, and a clamping apparatus. The socket is used for being located between and electrically conducting the chip module and the circuit board. The load plate is located at an outer side of the socket, and has a pressing member and an installing member fixed to the circuit board. The pressing member and the installing member are cooperative for fixing. The pressing member has an open position and a close position relative to the installing member. The installing member has a first identifier. The clamping apparatus has a second identifier corresponding to the mark. When the pressing member is located at the open position, the clamping apparatus is used for clamping the chip module, and placing the chip module on the socket by aligning the second identifier with the first identifier. When the pressing member is located at the close position, the pressing member is used for fixing the clamping apparatus together with the chip module to the circuit board.

In one embodiment, the clamping apparatus has a reserved portion corresponding to the mark, and the mark is exposed from the reserved portion.

In one embodiment, the first identifier and the second identifier are in a same color, and the color is different from colors of other structures of the load plate and the clamping apparatus.

In one embodiment, the installing member further has multiple fixing members and a positioning rack, the fixing members are used for fixing the positioning rack to the circuit board, and the first identifier is disposed at the positioning rack and/or one of the fixing members.

In one embodiment, the chip module is in a shape of a rectangular or a square, the mark is disposed at a corner of the chip module, and correspondingly, the first identifier and the second identifier are each disposed at an adjacent corner adjacent to the corner of the chip module having the mark.

In one embodiment, before the clamping apparatus clamps the chip module, a foolproof seat is provided to accommodate the chip module. The foolproof seat has a third identifier corresponding to the mark. After the chip module is disposed at the foolproof seat, the clamping apparatus correctly clamps the chip module by aligning the second identifier with the third identifier and the mark.

In one embodiment, the first identifier, the second identifier and the third identifier are in the same format or manner.

In one embodiment, the clamping apparatus has a main body portion and a supporting portion connected to each other, the main body portion is provided with an accommodating frame used for accommodating and positioning the chip module, the supporting portion urges the circuit board, when the pressing member is located at the close position, the pressing member presses the supporting portion downward, and the main body portion and/or the supporting portion are provided with the second identifier.

In one embodiment, the socket has a chamfer, the clamping apparatus is correspondingly provided with an inclined surface, and the chamfer and the inclined surface cooperate with each other and are used for fool-proofing.

In one embodiment, the pressing member has a reserved frame, and when the pressing member is located at the close position, the chip module is partially located at the reserved frame, the second identifier is at least partially exposed from the reserved frame, and the first identifier is exposed from an outer side of the pressing member.

Compared with the related art, certain embodiments of the present invention, among other things, have the following beneficial advantages.

In the electrical connection assembly of the present invention, the load plate is provided with the first identifier, the clamping apparatus is provided with the second identifier, and the mark of the chip module is aligned with the second identifier, so that the clamping apparatus correctly clamps the chip module. After the socket is installed to the circuit board, the load plate is correspondingly fixed to the outer side of the socket, then the first identifier is aligned with the second identifier and the mark, and thereby the clamping apparatus clamps the chip module to be correctly placed at the socket. In this way, it avoid erroneously installing the chip module at the socket, so as to ensure that the chip module and the circuit board are electrically conducted smoothly without error, thereby reducing the production cost, which is favorable to competitiveness.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is a schematic three-dimensional exploded view showing that a clamping apparatus clamps a chip module in an electrical connection assembly according to one embodiment of the present invention.

FIG. 2 is a schematic three-dimensional exploded view of a foolproof seat and the chip module before the clamping apparatus clamps the chip module in the electrical connection assembly according to one embodiment of the present invention.

FIG. 3 is a schematic three-dimensional exploded view showing that the clamping apparatus and the chip module are disposed at the foolproof seat before the clamping apparatus clamps the chip module in the electrical connection assembly according to one embodiment of the present invention.

FIG. 4 is an assembly view of FIG. 3.

FIG. 5 is a schematic three-dimensional exploded view showing that the clamping apparatus clamps the chip module and the foolproof seat in FIG. 4.

FIG. 6 is a schematic three-dimensional exploded view of the clamping apparatus clamping the chip module and before being placed at a socket and a load plate in FIG. 4.

FIG. 7 is a local assembly view showing that the clamping apparatus clamping the chip module is placed at the socket and the load plate in FIG. 1.

FIG. 8 is an entire assembly view showing that the clamping apparatus clamping the chip module and is placed at the socket and the load plate in FIG. 1.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

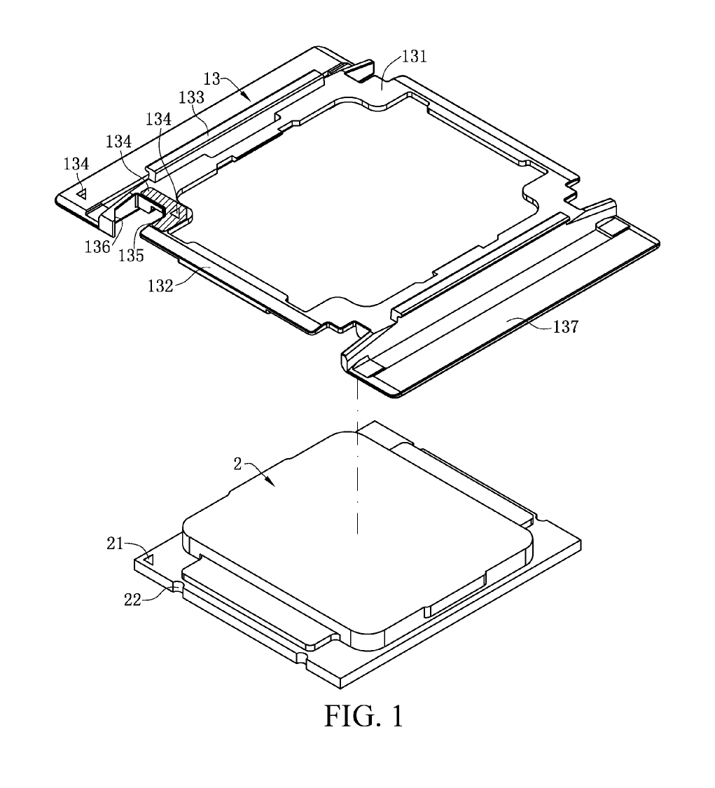

The description will be made as to the embodiments of the present invention in conjunction with the accompanying drawings in FIGS. 1-8. In accordance with the purposes of this invention, as embodied and broadly described herein, this invention, in one aspect, relates to an electrical connection assembly.

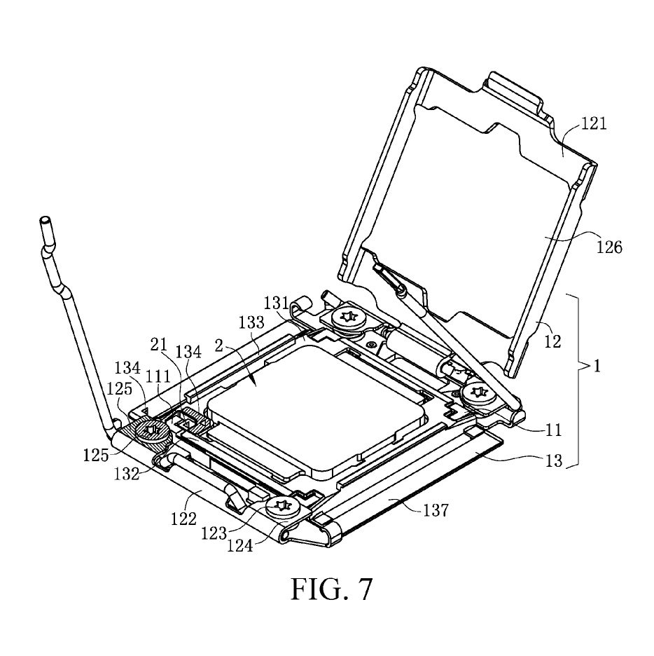

As shown in FIGS. 1 and 7, an electrical connection assembly 1 according to one embodiment of the present invention is used for electrically connecting a chip module 2 and a circuit board (not shown, the same below). The electrical connection assembly 1 is a land grid array (LGA) package. The chip module 2 is in a shape of a rectangular or a square. A corner of the chip module 2 is provided with a mark 21. The mark 21 is a triangular mark. Two sides of the chip module 2 are each symmetrically provided with two notches 22. Alternatively, in other embodiments, only one side of the chip module 2 is provided with a notch 22, or two sides of the chip module 2 are each provided with one notch 22.

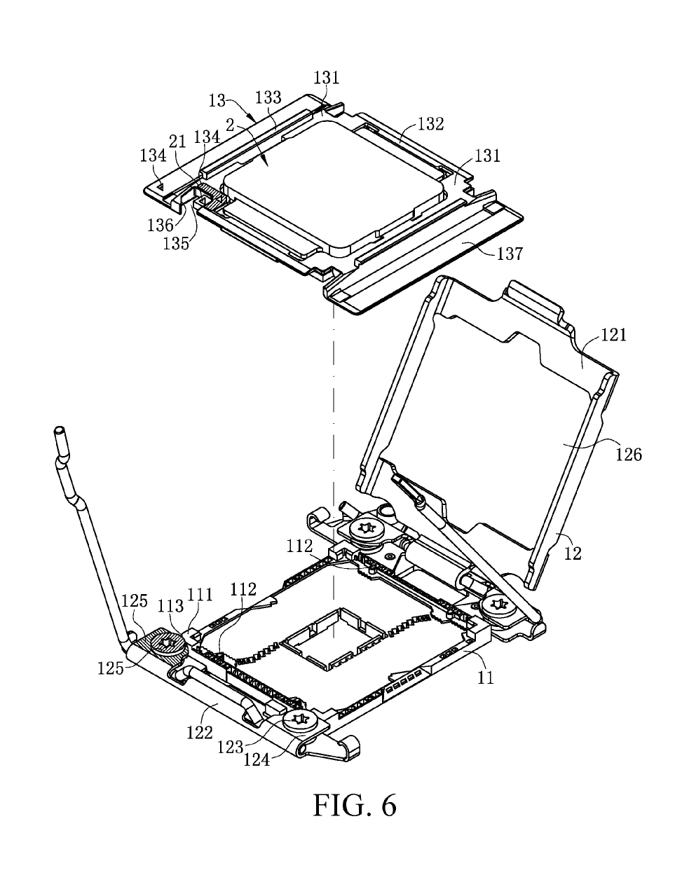

As shown in FIGS. 6 and 7, the electrical connection assembly 1 includes a socket 11 located between and electrically conducting the chip module 2 and the circuit board, a load plate 12 located at an outer side of the socket 11, and a clamping apparatus 13 used for clamping the chip module 2 to be placed at the socket 11.

As shown in FIG. 6, the socket 11 is soldered and installed to the circuit board. It is in a shape of a rectangular or square structure. Four stopping portions 111 are respectively located at four corners. The structure of each of the stopping portions 111 is in a shape of L. An accommodating space (not labeled, the same below) is formed between the four stopping portions 111. The chip module 2 is installed to the accommodating space downward. The stopping portion 111 is used for limiting movement of the chip module 2. An outer side of one of the stopping portions 111 adjacent to the mark 21 is provided with a chamfer 113.

As shown in FIG. 6, four foolproof blocks 112 are provided symmetrically at two sides of the socket 11 corresponding to the four notches 22. The foolproof blocks 112 are located in the notches 22, which facilitates positioning, and may also prevent erroneous installation. In other embodiments, there is one notch 22, there is also one foolproof block 112, and the quantity of the notches 22 corresponds to that of the foolproof blocks 112.

As shown in FIGS. 6-8, the load plate 12 frames the outer side of the socket 11, and is installed and fixed to the circuit board. The load plate 12 has a pressing member 121 and an installing member 122 cooperate with each other for fixing. The installing member 122 is fixed to the circuit board. The pressing member 121 has an open position and a close position relative to the installing member 122. The installing member 122 further has multiple fixing members 123 and a positioning rack 124. The multiple fixing members 123 are used for fixing the positioning rack 124 to the circuit board. Two first identifiers 125 are respectively disposed at the positioning rack 124 and one of the fixing members 123. The first identifier 125 is a green object, and is attached to the upper surface of the positioning rack 124 and the upper surface of the fixing member 123. The pressing member 121 further has a reserved frame 126. When the pressing member 121 is located at the close position, the chip module 2 is partially located at the reserved frame 126, the second identifier 134 is at least partially exposed from the reserved frame 126, and the first identifier 125 is exposed from an outer side of the pressing member 121.

In other embodiments, it may also be that, the first identifier 125 is only one in quantity, and is optionally disposed at the positioning rack 124 or the fixing member 123. In one embodiment, the first identifier 125 is in a non-green color such as blue or yellow. In one embodiment, the first identifier 125 is a triangular mark or an arrow mark, as long as it is a mark of a remarkably reminder. In one embodiment, the first identifier 125 is coated on the upper surface of the positioning rack 124 or the upper surface of the fixing member 123.

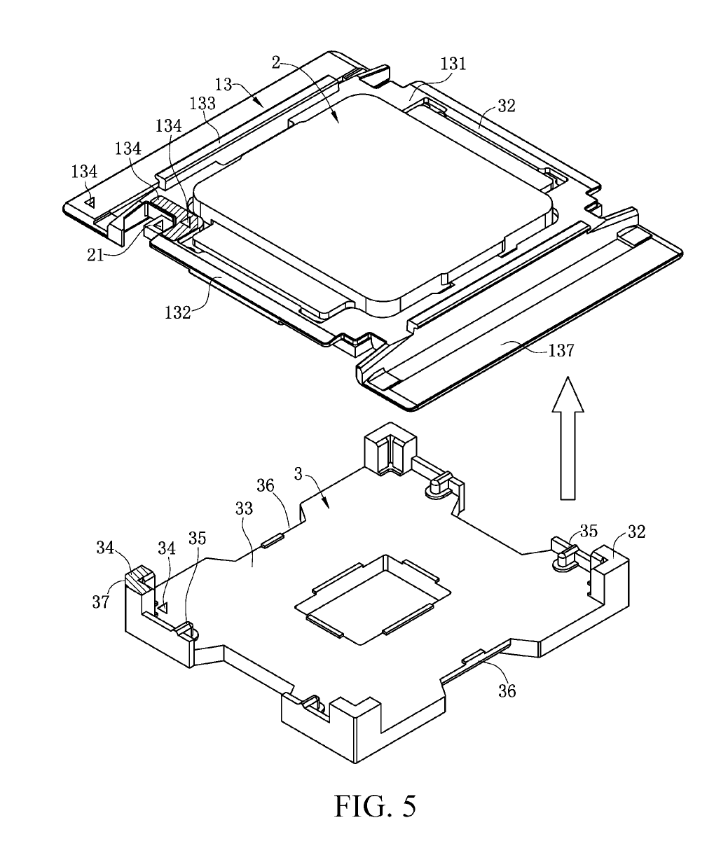

As shown in FIGS. 1 and 5, the clamping apparatus 13 has a main body portion 131 and a supporting portion 137 connected to each other. The main body portion 131 is provided with an accommodating frame 132 used for accommodating and positioning the chip module 2. Two sides of the main body portion 131 are each provided with a grasping portion 133, which helps an operator perform grasping. Positions on the upper surface of the main body portion 131 and the upper surface of the supporting portion 137 corresponding to the mark 21 and the first identifier 125 are each provided with a second identifier 134. In this way, the reminder is more remarkable, so as to avoid erroneous installation of the operator. The second identifier 134 is in a shape of L. The second identifier 134 of the main body portion 131 may be the same as or different from the second identifier 134 of the supporting portion 137. In this embodiment, the second identifier 134 of the main body portion 131 is different from the second identifier 134 of the supporting portion 137. The second identifiers 134 and the first identifier 125 are all green objects. In other embodiments, it may also be that, the second identifier 134 is only one in quantity, and is optionally disposed at the upper surface of the main body portion 131 or the upper surface of the supporting portion 137. In one embodiment, the second identifier 134 may be any format or manner as the first identifier 125, such as a non-green color, a triangular mark or an arrow mark, as long as it is a remarkable reminder.

As shown in FIGS. 1, 3 and 6, a position of the main body portion 131, next to one of the stopping portions 111 adjacent to the first identifier 125, is correspondingly provided with a reserved portion 135. The stopping portion 111 is located in the reserved portion 135 for a stopping function. The mark 21 is exposed from the reserved portion 135, which helps the operator observe whether it is aligned, so as to avoid erroneous installation. The main body portion 131 is provided with an inclined surface 136 corresponding to the chamfer 113. The chamfer 113 is parallel to the inclined surface 136. The inclined surface 136 is stopped at the outer side of the chamfer 113, and may further prevent the clamping apparatus 13 from moving outside the socket 11 besides playing a role of reminding.

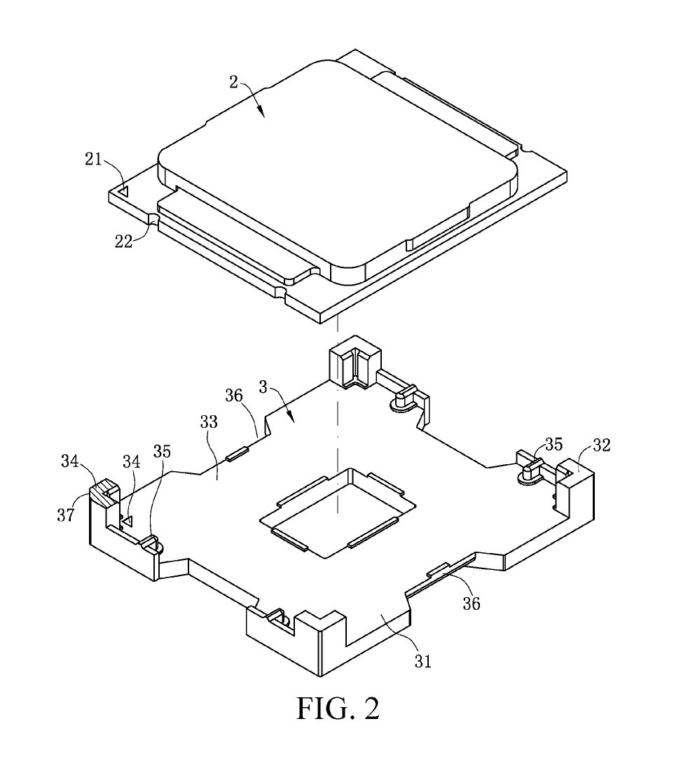

As shown in FIGS. 2-5, before the clamping apparatus 13 clamps the chip module 2, a foolproof seat 3 is provided to accommodate the chip module 2. The chip module 2 is first placed at the foolproof seat 3, and then the chip module 2 is correctly clamped correspondingly by using the clamping apparatus 13.

As shown in FIGS. 2-4, the foolproof seat 3 has a seat body 31. The seat body 31 has a shape of a rectangular or a square. Four limiting portions 32 are respectively located at four corners. The structure of each of the limiting portions 32 is in a shape of L. An accommodating space 33 is formed between the four limiting portions 32. The chip module 2 is installed to the accommodating space 33 downward. The limiting portions 32 are used for limiting movement of the chip module 2. One of the limiting portions 32 is provided with a third identifier 34. The third identifier 34 is in a shape of L, is a green object, and is attached to the upper surface of the limiting portion 32. When the chip module 2 is correctly installed to the accommodating space 33, the mark 21 corresponds to the third identifier 34, which facilitates observation of the operator, and avoids erroneous installation.

In other embodiments, it may also be that, the third identifier 34 is in a non-green color such as blue or yellow. In one embodiment, the third identifier 34 is a triangular mark or an arrow mark, as long as it is a remarkable reminder. In one embodiment, the third identifier 34 is coated on the limiting portion 32 or the color of the entire limiting portion 32 is green, as long as the color is different from colors of other structures of the seat body 31. In one embodiment, as shown in FIG. 2, the bottom surface of the accommodating space 33 may also be provided with the third identifier 34 corresponding to the mark 21, that is, the third identifiers 34 are two in quantity, and are respectively disposed at the bottom surface of the accommodating space 33 and the limiting portion 32, and therefore, reminding is more remarkable, so as to avoid erroneous installation of the operator. The third identifier 34 on the bottom surface of the accommodating space 33 may be the same as or different from the third identifier 34 of the seat body 31. In one embodiment, the third identifier 34 is only optionally disposed at the bottom surface of the accommodating space 33 or the limiting portion 32.

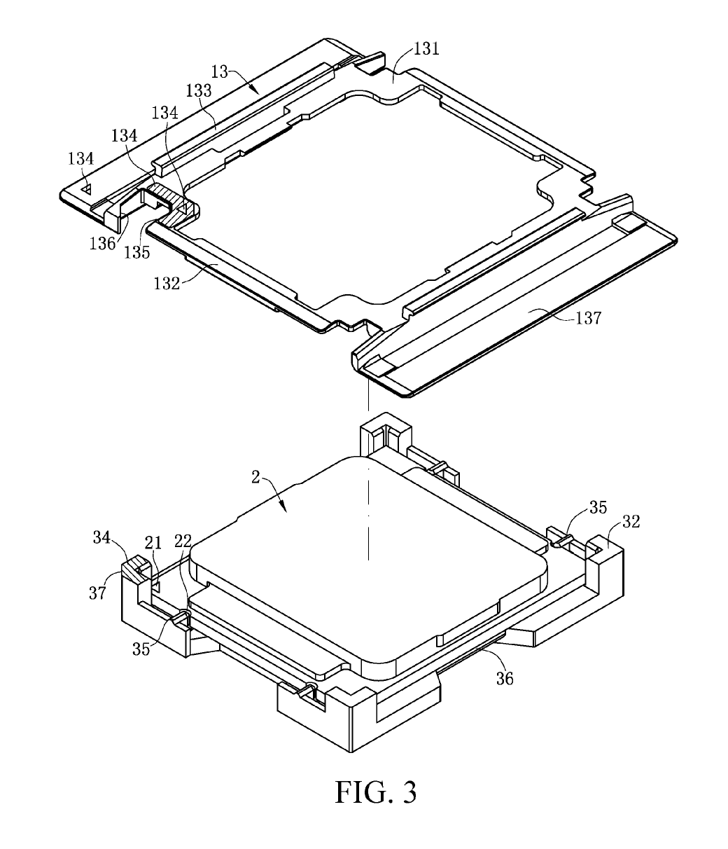

As shown in FIGS. 2 and 3, front and rear sides the seat body 31 may further be symmetrically provided with four positioning blocks 35 corresponding to the four notches 22. The positioning blocks 35 are located in the notches 22, which facilitates positioning, and may also prevent erroneous installation. In other embodiments, there is one notch 22, there is also one positioning block 35, and the quantity of the notches 22 corresponds to that of the positioning blocks 35. Left and right sides of the seat body 31 are each provided with a notched slot 36 corresponding to the grasping portion 133, which helps the operator perform grasping.

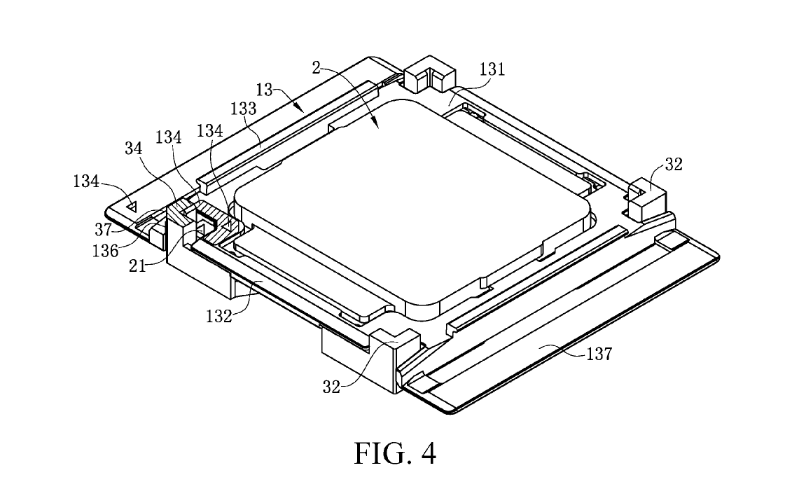

As shown in FIGS. 3 and 4, additionally, the outer side of the limiting portion 32 having the third identifier 34 is provided with a chamfer 37. The chamfer 37 may also be a third identifier, that is, there are three third identifiers, which are respectively disposed at the bottom surface of the accommodating space 33, the upper surface of the limiting portion 32 and the outer side of the limiting portion 32. In this way, reminding is more remarkable, so as to avoid erroneous installation of the operator. In other embodiments, it may also be that, there is only one third identifier 34, which is optionally disposed at the bottom surface of the accommodating space 33, the upper surface of the limiting portion 32 or the outer side of the limiting portion 32.

As shown in FIG. 4, in this embodiment, the first identifier 125, the second identifier 134 and the third identifier 34 are all located at a corner adjacent to the mark 21, the three are all in a same green color, the green color is different from colors of other structures of the load plate 12, the clamping apparatus 13 and the foolproof seat 3. In this way, reminding is more remarkable, so as to avoid erroneous installation of the operator. In other embodiments, the third identifier 34 may also be any format or manner as the second identifier 134 and the first identifier 125, such as a non-green color, a triangular mark or an arrow mark, as long as it is a remarkable reminder. In one embodiment, the third identifier 34 is not completely the same as or completely different from the second identifier 134 and the first identifier 125. For example, the first identifier 125 is the same as the second identifier 134, but the third identifier 34 is different from the first identifier 125, or the first identifier 125, the second identifier 134 and the third identifier 34 are all different from each other.

Assembly and operation steps are as follows.

As shown in FIGS. 3, 4 and 6, the socket 11 is first soldered to the circuit board. Then the load plate 12 is installed to the outer side of the socket 11. The positioning rack 124 is fixed to the circuit board by using the multiple fixing members 123, the pressing member 121 is located at the open position, and the chamfer 113 is adjacent to the first identifier 125. Meanwhile, the foolproof seat 3 is provided, align the mark 21 with the third identifier 34, and thereby the chip module 2 is correctly installed to the accommodating space 33. Then, align the second identifier 134 with the mark 21 and the third identifier 34, so that the clamping apparatus 13 correctly clamps the chip module 2. In this case, the third identifier 34 and the mark 21 are both exposed from the reserved portion 135. In this embodiment, the second identifier 134 located on the upper surface of the main body portion 131 and the third identifier 34 located on the upper surface of the limiting portion 32 are both in a shape of L, and are disposed opposite to each other to roughly form a quadrilateral, and the mark 21 is placed in the quadrilateral.

As shown in FIGS. 5-7, after the clamping apparatus 13 correctly clamps the chip module 2, the foolproof seat 3 is then removed. Next, the chip module 2 is clamped by the clamping apparatus 13, the mark 21 and the second identifier 134 are aligned with the first identifier 125, to enable the chip module 2 to be correctly placed at the socket 11.

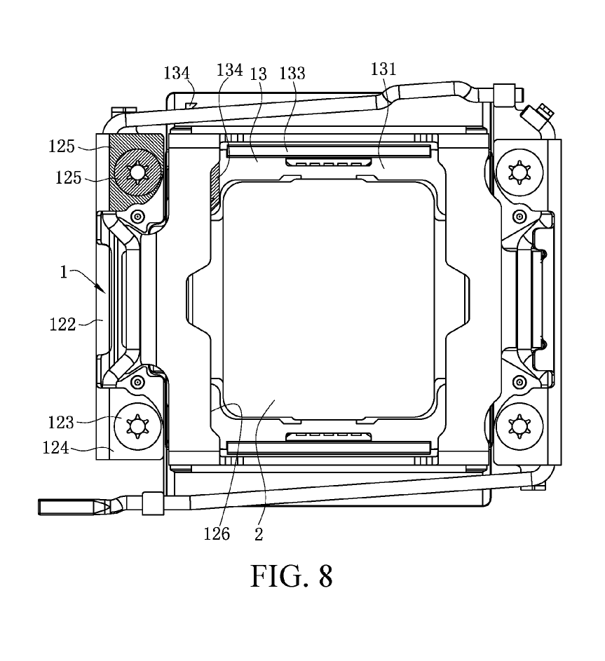

As shown in FIG. 8, finally, the pressing member 121 is located at the close position, and the pressing member 121 presses the main body portion 131, the supporting portion 137 and the chip module 2 downward, so that the pressing member 121 fixes the clamping apparatus 13 together with the chip module 2 to the socket 11 and the circuit board. In this case, the chip module 2 is partially located at the reserved frame 126, the second identifier 134 is at least partially exposed from the reserved frame 126, and the first identifier 125 is exposed from the outer side of the pressing member 121, which helps the operator and the user observe whether the assembly is correct.

To sum up, the electrical connection assembly 1 according to certain embodiments of the present invention has the following beneficial advantages.

The load plate 12 is provided with the first identifier 125, the clamping apparatus 13 is provided with the second identifier 134, and the clamping apparatus 13 correctly clamps the chip module 2 by aligning the second identifier 134 with the mark 21 of the chip module 2. After the socket 11 is installed to the circuit board, the load plate 12 is correspondingly fixed to the outer side of the socket 11, then by aligning the second identifier 134 and the mark 21 with the first identifier 125, the chip module 2 is clamped by the clamping apparatus 13 and correctly placed at the socket 11. In this way, it avoids erroneously installing the chip module 2 at the socket 11, so as to ensure that the chip module 2 and the circuit board are electrically conducted smoothly without error, thereby reducing the production cost, which is favorable to competitiveness.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connection assembly for electrically connecting a chip module and a circuit board, wherein the chip module has a mark, and the electrical connection assembly comprises:
a socket, located between and electrically conducting the chip module and the circuit board;
a load plate, located at an outer side of the socket, and having a pressing member and an installing member for cooperative fixing, the installing member fixed to the circuit board, the pressing member having an open position and a close position relative to the installing member, and the installing member having a first identifier; and
a clamping apparatus, having a second identifier corresponding to the mark,
wherein when the pressing member is located at the open position, the clamping apparatus is used for clamping the chip module, and placing the chip module on the socket by aligning the second identifier with the first identifier; and
when the pressing member is located at the close position, the pressing member is used for fixing the clamping apparatus together with the chip module to the circuit board.

2. The electrical connection assembly according to claim 1, wherein the clamping apparatus has a reserved portion corresponding to the mark, and the mark is exposed from the reserved portion.

3. The electrical connection assembly according to claim 1, wherein the first identifier and the second identifier are in a same color, and the color is different from colors of other structures of the load plate and the clamping apparatus.

4. The electrical connection assembly according to claim 1, wherein the installing member further comprises a plurality of fixing members and a positioning rack, the fixing members are used for fixing the positioning rack to the circuit board, and the first identifier is disposed at the positioning rack and/or one of the fixing members.

5. The electrical connection assembly according to claim 1, wherein the chip module is in a shape of a rectangular or a square, the mark is disposed at a corner of the chip module, and correspondingly, the first identifier and the second identifier are each located at an adjacent corner adjacent to the corner of the chip module having the mark.

6. The electrical connection assembly according to claim 1, wherein before the clamping apparatus clamps the chip module, a foolproof seat is provided to accommodate the chip module, the foolproof seat has a third identifier corresponding to the mark, after the chip module is disposed at the foolproof seat, the clamping apparatus correctly clamps the chip module by aligning the second identifier with the third identifier and the mark.

7. The electrical connection assembly according to claim 6, wherein the first identifier, the second identifier and the third identifier are the same.

8. The electrical connection assembly according to claim 1, wherein the clamping apparatus has a main body portion and a supporting portion connected to each other, the main body portion is provided with an accommodating frame used for accommodating and positioning the chip module, the supporting portion urges the circuit board, when the pressing member is located at the close position, the pressing member presses the supporting portion downward, and at least one of the main body portion and the supporting portion is provided with the second identifier.

9. The electrical connection assembly according to claim 1, wherein the socket has a chamfer, the clamping apparatus has an inclined surface, and the chamfer and the inclined surface cooperate with each other for fool-proofing.

10. The electrical connection assembly according to claim 1, wherein the pressing member has a reserved frame, and when the pressing member is located at the close position, the chip module is partially located at the reserved frame, the second identifier is at least partially exposed from the reserved frame, and the first identifier is exposed from an outer side of the pressing member.
